(19) United States
(12) Patent Application Publication
(10) Pub. No.: US 2017/0248148 A1
(43) Pub. Date: Aug. 31, 2017

(54) COMBINATION OF A CEILING FAN AND HEATER WITH LIGHT EFFECTS

(71) Applicant: SAFETY QUICK LIGHTING & FANS CORP., Alpharetta, GA (US)

(72) Inventor: RAN ROLAND KOHEN, Aventura, FL (US)

(73) Assignee: SAFETY QUICK LIGHTING & FANS CORP., Alpharetta, GA (US)

(21) Appl. No.: 15/515,664

(22) PCT Filed: Sep. 30, 2015
(86) PCT No.: PCT/US2015/053138

§ 371 Date: Mar. 30, 2017

Related U.S. Application Data
(60) Provisional application No. 62/057,565, filed on Sep. 30, 2014.

(51) Int. Cl. F04D 25/08; F04D 29/58; F04D 29/32; F21V 7/22; F24H 3/04; F21V 33/00; F21S 10/04; F04D 19/00; F04D 29/34

(52) U.S. Cl. CPC F04D 25/088; F04D 19/002; F04D 29/582; F04D 29/325; F04D 29/34; F24H 3/0411; F21V 33/0096; F21S 10/046; F21V 7/22; F21Y 2115/10

(57) ABSTRACT

A combination assembly or apparatus of a ceiling fan and heater. The combination assembly or apparatus includes a ceiling fan, a heater, a fan to blow air across the heater, a translucent band, motor driven rotating reflective foils each having mounted therein a light source (e.g. an LED) to shine through the translucent band to give a motion effect like a flickering.

### FIELD OF THE DISCLOSURE

The disclosure relates to a combination assembly or apparatus of a ceiling fan and heater. The disclosure also relates to a combination assembly or apparatus of a ceiling fan, a heater, a fan to blow air across the heater, a translucent band, motor driven rotating reflective foils each having mounted therein a light source (e.g. an LED) to shine through the translucent band to give a motion effect like a flickering.

### BACKGROUND

Ceiling fans are commonly utilized to assist in ventilation and circulation of air. Many different forms of ceiling fans with a plurality of blades driven by an electric motor suspended from the ceiling are commercially available on the market. The operation of the motor causes the blades to rotate about a vertical axis usually forcing air in a downward direction. Some ceiling fans have reversible motors so that the blades can rotate in a direction that forces air in an upward direction.

Switches are used to control the ceiling fan. Also it is known to support housings for light bulbs on the housing associated with the ceiling fan. Light kits for ceiling fans are well known and typically include one to five incandescent or halogen light sources. Fluorescent light sources have also been disclosed for use with ceiling fans. Operation of ceiling fans is usually for the purpose of ventilation and/or circulation of air. The main function of a ceiling fan is to merely move air within a room without adding heat to the air which passes the fan.

While ceiling fans are used almost exclusively under warm conditions, they are also of potential value in cool and cold weather, when enclosed spaces must be heated. Since hot air rises, rooms tend to be heated from the top down, lengthening the discomfort endured by their occupants from the cold, particularly when ceilings are high. This is also wasteful of energy, because the upper portion of a room is not occupied. As ceiling fans tend to bring air close to the ceiling of a room down towards the center of the room, ceiling fans can increase the comfort of occupants of cold rooms while they are being heated through their circulation of the room's air, and reduce energy costs. On the other hand, the slight draft they create, so pleasant on a sultry day, may have the opposite effect on a cold one.

It is also known to have the fan air blown through a heater, so that the fan air is heated. The disclosure relates to an improved combination assembly of a ceiling fan and heater, which in some embodiments includes lighting effects.

### SUMMARY OF THE DISCLOSURE

An apparatus for distributing heated air to a room environment comprises: a ceiling fan assembly having a main housing composed of a ceiling mounting portion housing, an upper housing portion, a rotating housing portion from which a plurality of fan blades extend in a horizontal plane to create a downward air flow, and a lower housing portion, with the housing portions structurally interconnected internally of the main housing and electrical wires extending from the top of the ceiling mounting portion centrally through the main housing. The apparatus also includes a ceiling fan motor for rotating the rotating housing portion, a heater mounted at the bottom of the lower housing portion, a skirt enclosing at least a portion of the heater, and a heating fan driven by a heating fan motor mounted within the lower housing to pass air over the heater. The heated air output from the heater mixes with the downward air flow from the plurality of fan blades to distribute heat and air circulation in a room environment.

The apparatus can include a translucent band surrounding the lower housing portion in a horizontal plane between the fan blades and the heater, a plurality of reflective foils mounted for rotation in the main housing in the lower housing portion in the horizontal plane, and lighting elements mounted with the reflective foils to shine light through the translucent band. A spin motor can be included for rotating the plurality of reflective foils. In one embodiment, each of the plurality of reflective foils radially extending from the spin motor on a corresponding one of a plurality of spokes.

The apparatus can include a quick attachable-detachable device having a plug and mating socket, wherein the plug is secured to the ceiling mounting portion housing. Furthermore for coupling the heater to the lower housing portion, a second quick attachable-detachable device having a plug and mating socket can be included, with the plug secured to the heater and the mating socket secured to the bottom of the lower housing portion.

In some embodiments, the lighting elements are LEDs. In some embodiments, the heater is a ceramic heater. In some embodiments, the plurality of blades are detachably connected to the rotating housing portion. In some embodiments, the heater and heating fan motor are only operable when the ceiling fan motor is operating.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 shows a perspective view as seen looking slightly downwardly of one embodiment of the assembly or apparatus according to the disclosure.

FIG. 2 shows a perspective view as seen looking slightly upwardly of the assembly or apparatus of FIG. 1.

FIG. 3 shows a larger perspective view as seen looking slightly upwardly of the assembly or apparatus of FIG. 1 with no lighting effect.

FIG. 4 shows a partially cutaway longitudinal view structure through its mid-axial plane showing schematically the components of the assembly or apparatus of FIG. 1.

FIG. 5 shows a partially cutaway longitudinal section view structure through its mid-axial plane showing schematically the components of another embodiment of the assembly or apparatus according to the disclosure.

### DETAILED DESCRIPTION

As required, embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a representative basis for teaching one skilled in the art to variously employ the present subject matter in virtually any appropriately detailed structure and function. Further, the terms and phrases used herein are not intended to be limiting, but rather, to provide an understandable description of the concepts.

The terms “a” or “an”, as used herein, are defined as one or more than one. The term plurality, as used herein, is defined as two or more than two. The term another, as used herein, is defined as at least a second or more. The terms “including” and “having,” as used herein, are defined as comprising (i.e., open language). The term “coupled,” as used herein, is defined as “connected,” although not necessarily directly, and not necessarily mechanically.

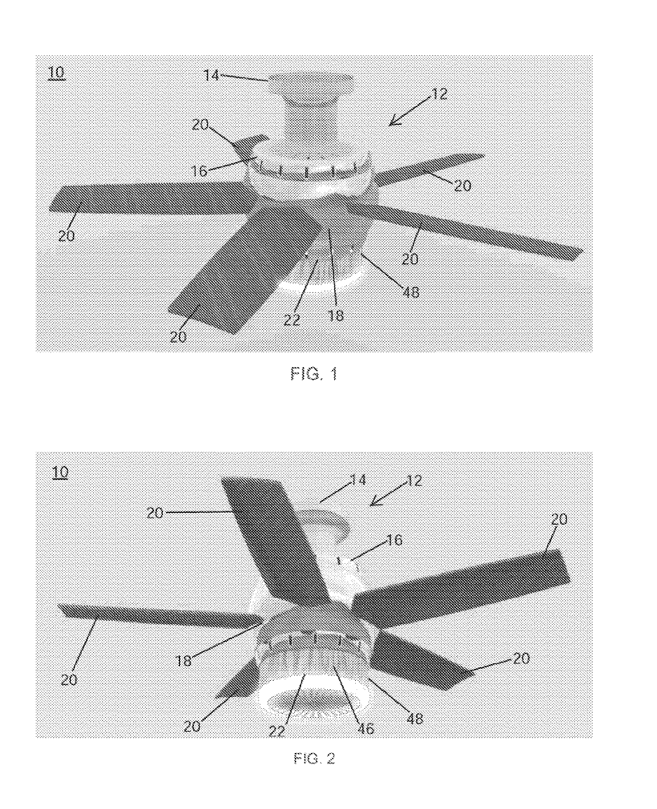

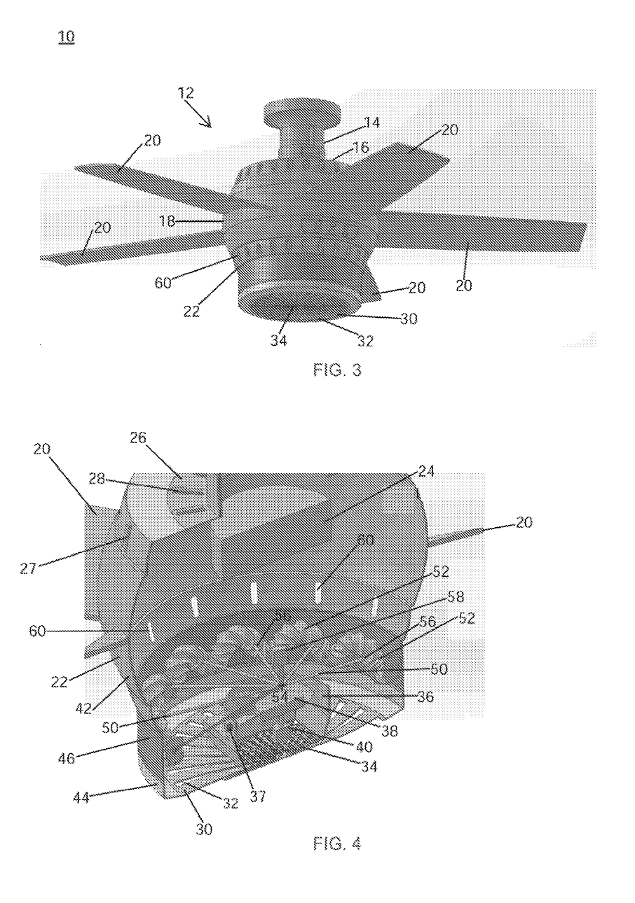

Referring now to the drawings, a specific embodiment of the assembly or apparatus 10 according to the disclosure is shown schematically in FIGS. 1-4. As seen in FIGS. 1-3, the assembly or apparatus 10 comprises a main housing 12 composed of a ceiling mounting portion housing 14, an upper housing portion 16, a rotating housing portion 18 from which a plurality of fan blades 20 extend radially outward, and a lower housing portion 22. Although five fan blades 20 are shown, any suitable number of fan blades 20 can be used and the fan blades 20 can be integral to rotating housing portion 18 or attached to rotating housing portion 18 so as to be replaceable. Regardless of the number of fan blades 20, the fan blades can extend substantially horizontally (i.e. parallel to a ceiling that has no angle relative to the floor) or be angled relative to the ceiling.

The various housing portions 14, 16, 18, and 22 are structurally interconnected internally of the main housing 12 and for aesthetics electrical wires and cables preferably extend from the top of the ceiling mounting portion centrally through the main housing. As this structure can take many forms, it will be apparent to those skilled in the art how the interconnections are centrally made and how the wiring and cabling takes place, therefore these details are omitted for sake of clarity.

A ceiling fan motor 24 is shown schematically in FIG. 4 mounted in the main housing within the upper housing portion 16 and rotating housing portion 18 and its output shaft (not shown) is engaged, for example, via suitable gearing (not shown) with a ring gear (not shown) fixed to the rotating housing portion 18, so that operation of ceiling fan motor 24 causes rotating housing portion 18 with fixed fan blades 20 to rotate, in turn causing a circular air flow to be directed downwardly. In embodiments in which ceiling fan motor 24 is reversible, the circular air flow can be directed upwardly. Rotating housing portion 18 is supported in a known manner by suitable bearing surfaces (not shown) provided by upper housing portion 16 and lower housing portion 22. A grill 26, having radial slots 28, forms the top of the upper housing portion 16. Upper housing 16 has longitudinal slots 27 peripherally spaced to enable air to enter the upper housing 16. Radial slots 28 and longitudinal slots 27 enable air to enter the main housing above the ceiling fan motor 24 for cooling of the motor and then passage into the lower housing 22. Any combination and configuration of radial slots 28 and longitudinal slots 27 that enable sufficient air entry is contemplated by the disclosure.

The bottom of the lower housing portion 22 is closed off by a grill 30, having radial slots 32. Any suitable number of slots 32 in any suitable shape other than radial is contemplated by the disclosure. The central portion of grill 30 is cutout and a heating element such as a ceramic heater or heating coil 34 is fitted into the cutout. Wiring (not shown) extending from the top of the main housing 12 is connected to power the ceramic heater 34. Skirt or circular structure 36, of substantially the same diameter as or slightly larger than the ceramic heater 34 is mounted above the ceramic heater 34 to form an air tunnel. Within the circular structure 36 is mounted a heating fan 38 driven by a heating fan motor 40, also powered by wiring (not shown) extending from the top of the main housing 12. It should be noted that ceramic heater 34 and heating fan motor 40 can be electrically connected so that ceramic heater 34 and heating fan motor 40 can be switched on or off independent of ceiling fan motor 24. Alternatively, ceramic heater 34 and heating fan motor 40 can be electrically connected so that ceramic heater 34 and heating fan motor 40 can be switched on (or off) only when ceiling fan motor 24 is running.

In operation, the ceramic heater 34 heats air that enters the air tunnel and is blown over the ceramic heater 34 by the heating fan 38. Like the air flow output of the blades 20, the heated air flow output by the ceramic heater 34 is directed downwardly. When both the ceiling fan blades 20 and ceramic heater 34 are functioning, the heated air from the ceramic heater flows downwardly conically expanding outwardly due to diffusion and mixes with the flow of air from the ceiling fan blades 20. When the mixed flow reached the floor of the room in which the ceiling fan is mounted, the air flow spreads outwardly until it encounters the walls whereupon it will rise upwardly toward the ceiling.

Referring to FIG. 4, the lower housing portion 22 is spherically shaped at its upper part 42 and terminates at its lower part 44 in a cylindrical shape. A part of the cylindrical shape is composed of a translucent band 46 that can have axially colored striping 48 on its face, see FIGS. 1 and 2. The lower housing portion above the translucent band 46 is cutout with peripherally spaced, longitudinally extending (or other shaped) slots 60 to enable air to enter the lower housing portion 22 and supply the ceramic heater 34 via the air tunnel. Within the lower housing portion 22, above the ceramic heater 34, is mounted a series of spokes 50 connected together at one end 54 along the axis of the main housing 12 and extend radially (or transversely) toward the translucent band 46. At the radial outer end 56 of each spoke is mounted a reflective foil 52 that acts as a reflector for a light source, which can be the light generated by the ceramic heater or another light such, such as LEDs 37 or other lighting element. The LEDs can be mounted on the end or any part of the spokes or foils or spaced a distance from the foils. The spokes are mounted for rotary motion, and the LEDs are powered by wiring extending from the top of the main housing in any known way. The rotary motion is achieved by a reflective foil spin motor 58 mounted above the spokes, so that the light shines through the translucent band 46 and is viewed on the exterior as a flame flickering due to the striping 48.

The main housing is intended to be mounted to a ceiling via a junction box using convention techniques or a quick attachable-detachable assembly as previously disclosed. This disclosure of the quick attachable-detachable assembly is found in U.S. Pat. No. 7,462,066 filed Mar. 20, 2007; U.S. Pat. No. 7,192,303 filed Dec. 2, 2004; and U.S. Pat. No. 6,962,498 filed Dec. 12, 2001 and U.S. Patent Application Publication No. 20090280673 filed Dec. 2, 2005. The contents of all of which are hereby incorporated herein by reference in their entirety.

The controls for the three motors 24, 40 and 58 can be manually controlled by switches (wall mounted or on assembly 10) or provided wirelessly via a controller and RF or other wireless setup in a known manner.

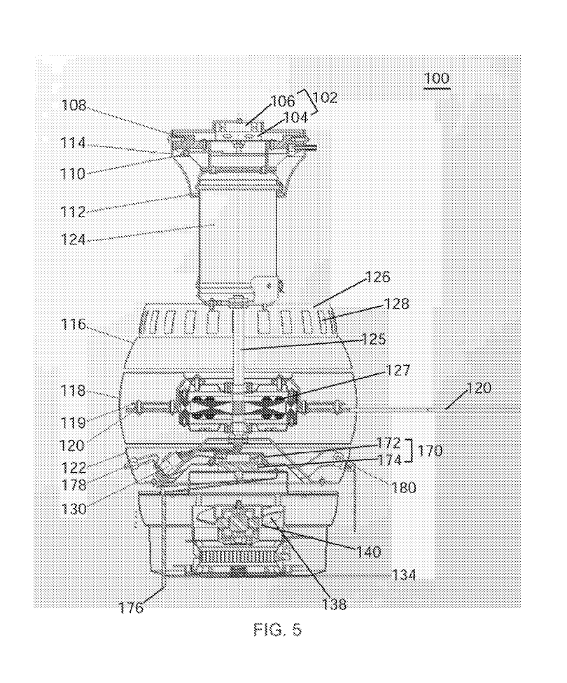

Another specific embodiment of the assembly or apparatus 100 according to the disclosure is shown schematically in FIG. 5. The assembly or apparatus 100 comprises a ceiling mounting portion housing 114, an upper housing portion 116, a rotating housing portion 118 from which a plurality of fan blades 120 (only two blades partially shown) extend radially outward, and a lower housing portion 122. Any suitable number of fan blades 120 can be used and the fan blades 120 can be integral to rotating housing portion 118 or attached to rotating housing portion 118 via connectors 119 so as to be replaceable. Regardless of the number of fan blades 120, the fan blades can extend substantially horizontally (i.e. parallel to a ceiling that has no angle relative to the floor) or be angled relative to the ceiling.

The various housing portions 114, 116, 118, and 122 are structurally interconnected and for aesthetics electrical wires and cables preferably extend from the top of the ceiling mounting portion 114 centrally through the various housing portions 114, 116, 118, and 122. As this structure can take many forms, it will be apparent to those skilled in the art how the interconnections are centrally made and how the wiring and cabling takes place, therefore these details are omitted for sake of clarity.

The ceiling mounting portion is intended to be mounted to a ceiling via a junction box using convention techniques or a quick attachable-detachable assembly as previously disclosed. This disclosure of the quick attachable-detachable assembly is found in U.S. Pat. No. 7,462,066 filed Mar. 20, 2007; U.S. Pat. No. 7,192,303 filed Dec. 2, 2004; and U.S. Pat. No. 6,962,498 filed Dec. 12, 2001 and U.S. Patent Application Publication No. 20090280673 filed Dec. 2, 2005. The contents of all of which are hereby incorporated herein by reference in their entirety.

As shown in FIG. 5, a quick attachable-detachable assembly 102 for installing assembly 100 comprises the combination of a plug 104 and mating socket 106. The plug 104 and mating socket 106 of the quick attachable-detachable assembly 102 function to both establish an electrical connection between assembly 100 and electrical supply wiring, and mechanically support assembly 100 on a surface, typically a ceiling. Plug 104 is fixedly secured to assembly 100 such as with coupling 108, while the socket 106 is secured to either the ceiling on which the assembly 100 is to be mounted, or to an electrical junction box.

The quick detachment of plug 104 and socket 106 can be actuated by release 110. This structure, function, and operation as well as the general structure, function, and operation of plug 104 and mating socket 106 have already been detailed in, for example, the patents and application incorporated by reference herein.

A ceiling fan motor 124 is shown schematically in FIG. 5 mounted to and partially within a lower part 112 of ceiling mounting portion housing 114. Alternatively, ceiling fan motor 124 can be mounted completely within ceiling mounting portion housing 114 and/or upper housing portion 116. Rotating housing portion 118 and output shaft 125 of ceiling fan motor 124 engage, for example, via suitable gearing 127 such as a ring gear fixed to the rotating housing portion 118, so that operation of ceiling fan motor 124 causes rotating housing portion 118 with fixed fan blades 120 to rotate, in turn causing a circular air flow to be directed downwardly. In embodiments in which ceiling fan motor 124 is reversible, the circular air flow can be directed upwardly. Rotating housing portion 118 is supported in a known manner by suitable bearing surfaces (not shown) provided by upper housing portion 116 and lower housing portion 122. A grill 126, having radial slots 128, forms the top of the upper housing portion 116. Upper housing 116 has slots (not visible in FIG. 5) peripherally spaced to enable air to enter the upper housing 116. Radial slots 128 and other slots enable air to enter for cooling of the ceiling fan motor 124 and then passage into the lower housing 122. Any combination and configuration of slots that enable sufficient air entry is contemplated by the disclosure.

A heating element such as a ceramic heater or heating coil 134 is connected to the bottom of the lower housing portion 122. Wiring 130 extending through assembly 100 is connected to power the ceramic heater 134. The connection between ceramic heater 134 and lower housing portion 122 can be made in any number of known ways, but FIG. 5 shows the connection using a quick attachable-detachable assembly 170, which comprises the combination of a plug 174 and mating socket 172. The plug 174 and mating socket 172 of the quick attachable-detachable assembly 170 function to both establish an electrical connection between ceramic heater 134 and electrical supply wiring, and mechanically couple ceramic heater 134 to lower housing portion 122. Plug 174 is fixedly secured to ceramic heater 134, while the socket 172 is secured to lower housing portion 122.

The quick detachment of plug 174 and socket 172 can be actuated by release 176. This structure, function, and operation as well as the general structure, function, and operation of plug 174 and mating socket 172 have already been detailed in, for example, the patents and application incorporated by reference herein.

As shown in FIG. 5, a heating fan 138 is driven by a heating fan motor 140, also powered by wiring 130. It should be noted that ceramic heater 134 and heating fan motor 140 can be electrically connected so that ceramic heater 134 and heating fan motor 140 can be switched on or off (which is controlled, for example by switch 178) independent of ceiling fan motor 124 (which is controlled, for example by switch 180). Alternatively, ceramic heater 134 and heating fan motor 140 can be electrically connected so that ceramic heater 134 and heating fan motor 140 can be switched on (or off) only when ceiling fan motor 124 is running.

In operation, the ceramic heater 134 heats air and is blown over the ceramic heater 134 by the heating fan 138. Like the air flow output of the blades 120, the heated air flow output by the ceramic heater 134 is directed downwardly. When both the ceiling fan blades 120 and ceramic heater 134 are functioning, the heated air from the ceramic heater flows downwardly conically expanding outwardly due to diffusion and mixes with the flow of air from the ceiling fan blades 120. When the mixed flow reached the floor of the room in which the ceiling fan is mounted, the air flow spreads outwardly until it encounters the walls whereupon it will rise upwardly toward the ceiling.

The disclosure also contemplates that the assembly of FIG. 5 can have the lighting effect discussed above with reference to FIGS. 1-4. The controls for motors 124, 140 and a reflective foil spin motor, if so provided, can be manually controlled by switches (wall mounted or on assembly 100) or provided wirelessly via a controller and RF or other wireless setup in a known manner.

All references cited herein are expressly incorporated by reference in their entirety. It will be appreciated by persons skilled in the art that the present disclosure is not limited to what has been particularly shown and described herein above. In addition, unless mention was made above to the contrary, it should be noted that all of the accompanying drawings are not to scale. There are many different features to the present disclosure and it is contemplated that these features may be used together or separately. Thus, the disclosure should not be limited to any particular combination of features or to a particular application of the disclosure. Further, it should be understood that variations and modifications within the spirit and scope of the disclosure might occur to those skilled in the art to which the disclosure pertains. Accordingly, all expedient modifications readily attainable by one versed in the art from the disclosure set forth herein that are within the scope and spirit of the present disclosure are to be included as further embodiments of the present disclosure.

1. An apparatus for distributing heated air to a room environment comprising: a ceiling fan assembly having a main housing composed of a ceiling mounting portion housing, an upper housing portion, a rotating housing portion from which a plurality of fan blades extend in a horizontal plane to create a downward air flow, and a lower housing portion, wherein the housing portions are structurally interconnected internally of the main housing and electrical wires extend from the top of the ceiling mounting portion centrally through the main housing, a ceiling fan motor for rotating the rotating housing portion, a heater having a preselected shape mounted at the bottom of the lower housing portion, a skirt enclosing the preselected shape of the heater, and a heating fan driven by a heating fan motor mounted within the lower housing to pass air over the heater, wherein the heated air output from the heater mixes with the downward air flow from the plurality of fan blades to distribute heat and air circulation in a room environment.

2. The apparatus of claim 1 further including a translucent band surrounding the lower housing portion in a horizontal plane between the fan blades and the heater.

3. The apparatus of claim 2 further including a plurality of reflective foils mounted for rotation in the main housing in the lower housing portion in the horizontal plane.

4. The apparatus of claim 3 further including lighting elements mounted with the reflective foils to shine light through the translucent band.

5. The apparatus of claim 4 further comprising a spin motor for rotating the plurality of reflective foils.

6. The apparatus of claim 5 further comprising a plurality of spokes, each of the plurality of reflective foils radially extending from the spin motor on a corresponding one of the plurality of spokes.

7. The apparatus of claim 6 further comprising a quick attachable-detachable device having a plug and mating socket, wherein the plug is secured to the ceiling mounting portion housing.

8. The apparatus of claim 6 further comprising a quick attachable-detachable device having a plug and mating socket, wherein the plug is secured to the heater and the mating socket is secured to the bottom of the lower housing portion.

9. The apparatus of claim 6 wherein the lighting elements are LEDs.

10. The apparatus of claim 6 wherein the heater is a ceramic heater.

11. The apparatus of claim 6 wherein the plurality of blades are detachably connected to the rotating housing portion.

12. The apparatus of claim 6 wherein the heater and heating fan motor are only operable when the ceiling fan motor is operating.
